(19) United States
(12) Patent Application Publication
(10) Pub. No.: US 2005/0055277 A1
(43) Pub. Date: Mar. 10, 2005

(54) System and method for facilitating product placement advertising

(76) Inventors: Betsy Ann Green, Marina del Rey, CA (US); Sally Green Cameron, McKinney, TX (US)

Correspondence Address: Baker & Daniels, Suite 700, 805 15th Street, N.W., Washington, DC, 20005, US

(21) Appl. No.: 10/888,825

(22) Filed: Jul. 9, 2004

Related U.S. Application Data
(60) Provisional application No. 60/485,397, filed on Jul. 9, 2003.
(60) Provisional application No. 60/535,810, filed on Jan. 13, 2004.

(51) Int. Cl. G06F 17/60

(52) U.S. Cl. 705/14

(57) ABSTRACT

According to one aspect of the present invention, there is provided a method for facilitating the buying and selling of product placement advertisement which includes: registering potential purchasers of a product placement advertisement; entering descriptive information regarding product placement opportunities; providing access to the descriptions of available product placement opportunities; providing a data entry system for entering specific search criteria for searching product placement opportunities; searching entered descriptive information for product placement opportunities; and selecting product placement opportunities for viewing based on relevance to the entered search criteria.

### RELATED U.S. APPLICATION DATA

This application claims priority to U.S. Provisional Application No. 60/485,397 filed Jul. 9, 2003; and U.S. Provisional Application No. 60/535,810 filed Jan. 13, 2004.

### BACKGROUND OF THE INVENTION

1. Field of the Invention

The present invention relates to a system and method for facilitating the efficient and timely use of product placement advertisements.

2. Description of the Related Art

Product placement is an advertising technique in which an advertised product is incorporated as part of the content of another product such as movie, video game, TV show, book, movie or even another advertisement. Product placement advertisement is growing field which has become increasingly more important as a source of revenue. This is particularly true in fields where viewing patterns and new technologies, such as Digital Video Recorders (DVRs), have made it easier and easier for consumers to skip over unwanted stand-alone advertisements.

As the value of product placement has increased, the number of opportunities for product placements have also increased through the use of digital editing. Many of these new digital editing techniques are well-know and discussed in U.S. Application Pub. No. US2003/0028432. Using such digital editing techniques, product placement advertisements can now be inserted at any time during the life a video product

Today, however, despite the increased value of product placements and the great number of product placement opportunities, buyer and sellers of product placement advertising have been unable to take advantage of the huge potential of this market. The primary obstacle to most product placement advertising is the speed of production and length of time required to negotiate product placement agreements. Using known techniques, the time required to identify and negotiate each product placement advertisement is not easily reduced because of the uniqueness of each product placement opportunity. Countless factors affect such negations and the slightest detail can alter the value of the product placement. Accordingly, each product placement advertisement generally requires a separate negotiation between each buyer and seller. This process is further slowed by the persistent difficulty of properly identify and contacting the right decision makers to negotiate each product placement opportunity and to turn it into a product placement advertisement.

Because of the difficulties described above, many, if not most, product placement opportunities today are not capitalized upon. Accordingly, what is needed is a new system which will enable sellers to quickly list product placement opportunities and for buyers to be able search and identify the right product placement opportunities for them. What is further needed is a system which will allow buyers and sellers to identify and contact the right decision makers to negotiate each product placement opportunity as they arise so that they can be quickly acted upon.

### SUMMARY OF THE INVENTION

According to one aspect of the invention, there is provided a method for facilitating the buying and selling of product placement advertisements which includes: registering potential purchasers of a product placement advertisement; entering descriptive information regarding product placement opportunities; providing access to the descriptions of available product placement opportunities; providing a data entry system for entering specific search criteria for searching product placement opportunities; searching entered descriptive information for product placement opportunities; and selecting product placement opportunities for viewing based on relevance to the entered search criteria.

### BRIEF DESCRIPTION OF THE DRAWINGS

FIG. 1 is a simplified schematic representation illustrating one example of a computer network configuration for use with one embodiment of the present invention.

FIG. 2 is a simplified schematic representation illustrating one example of a computer system for use with one embodiment of the present invention.

FIG. 3 shows a general flowchart for the operation of one aspect of the present invention.

FIGS. 4-22 show selected screen shots according to a first exemplary embodiment of the present invention which illustrate selected aspects of the present invention.

### DESCRIPTION OF THE PREFERRED EMBODIMENTS

Reference will now be made in detail to the exemplary embodiments of the invention, an example of which is illustrated in the accompanying drawings in which like reference characters refer to corresponding elements. Preferably, the system and method of the present invention described below may be implemented by an interactive computer software application incorporated within a computer-readable medium such as a hard disk drive, an optical medium such as a compact disk, or the like. Further, the computer-readable medium may be available to a user either locally on the user's computer or remotely over a computer network, such as a local area network (LAN) or through the Internet.

In the preferred embodiment, the steps of the present invention are embodied in machine-executable instructions. These instructions can be used to cause a processor to perform the steps of the present invention. Alternatively, the steps of the present invention might be performed by hardware components, or by any combination of software and hardware components.

As a product, the present invention may be provided as software which may be used to program a computer (or other devices) to perform according to the present invention. As software, the present invention may be stored and transmitted to a variety of machine-readable medium including, for instance, RAM, EPROM, CD-ROM, ROMs floppy diskettes, optical disks, optical cards, or other type of media/machine-readable media.

Further, the present invention as software shall preferably be capable of being provided, transmitted and/or downloaded from a remote computer (i.e. a server) to a requesting computer (i.e., a client) via a communication link (e.g., a modem or network connection).

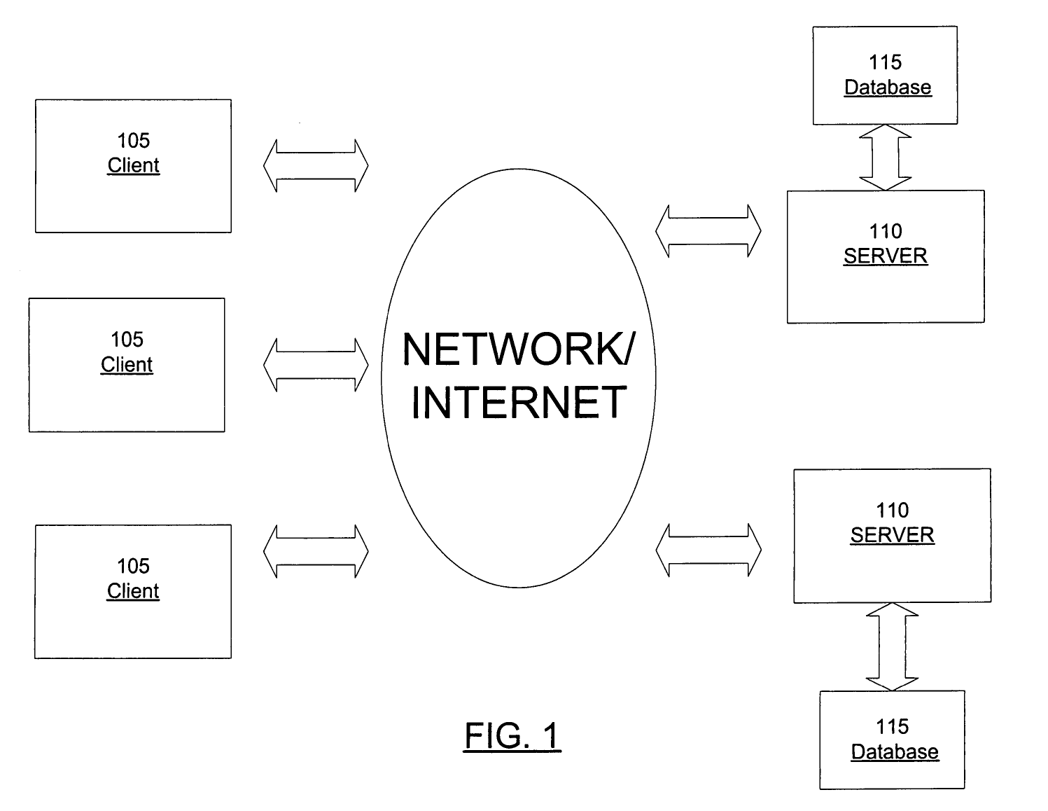

FIG. 1 is a simplified view of an exemplary client-server environment within which the present invention has been designed to optimally function. This architecture is commonly know as the client-server model. The basic technology and structure of this model are discussed at length in Client/Server Architecture, 2^{nd} Ed., by Alex Berson (Magraw Hill 1996) which is incorporated by reference in its entirety to the present disclosure. It should be understood that the present invention operates independent of any particular arrangement or mix of network components and that FIG. 1 is purely illustrative and simplified for the purpose of explanation.

Within the client/server model, each client 105 acts as a requester of information; and each server 110 generally provides the data and services requested by each client 105. With reference to FIG. 1, clients 105 and servers 110 may communicate using a variety of protocols such as HyperText Transfer Protocol (HTTP). To access or request information, clients 105 may use a web browsers (i.e. Internet Explorer) to select a document by providing its Uniform Resource Locator (URL) to the servers 110. The URL may be entered manually or it may be sent by the user clicking on an embedded link containing the URL. In response to a selected URL, the web browser operates by forwarding a selected URL to the server 110, which in turn initiates a request for the document corresponding to the URL. The server 110 then transmits the requested document to the appropriate client 105 for viewing. Preferably, each server may have further access to internal and/or external databases 115 to allow for storing and retrieving information.

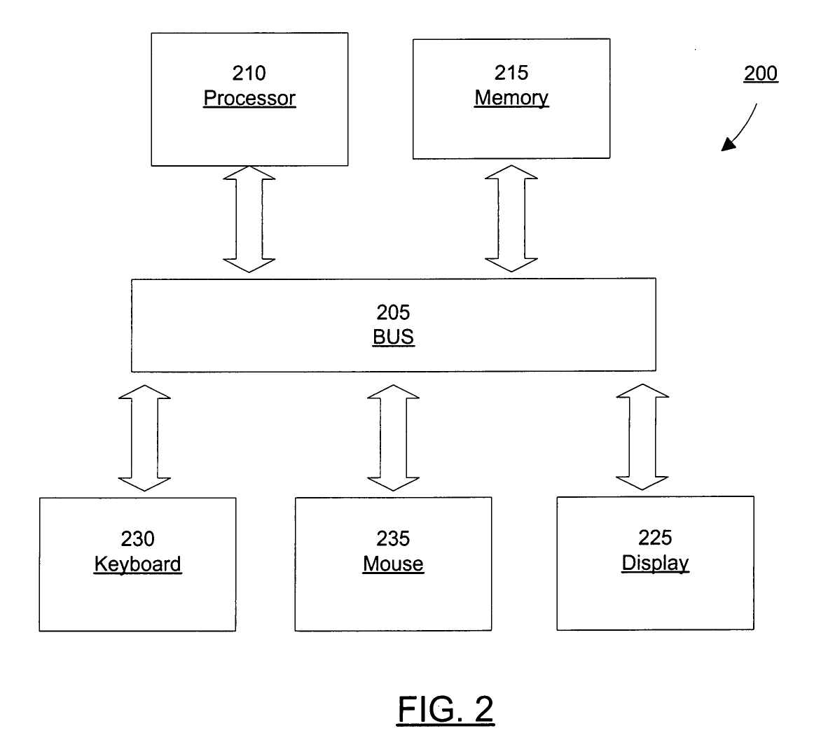

An exemplary computer system 200 in which features of the present invention may be implemented will now be described with reference to FIG. 2. As shown, computer system 200 comprises a bus 205 for communicating information internally within the computer system 200 and a processor 210 for processing information. The computer system 200 further comprises memory 215 for storing information and instructions to be executed by the processor 210.

The computer system 200 can also be coupled via a bus 205 to a display element 225 (i.e. a computer screen or monitor), for displaying information. Preferably, input devices such as a keyboard 230, mouse 235 along with other devices may also be coupled to a bus 205 for communicating information to the processor 210. Further, a modem (internal or external) or network interface device may be preferably used for allowing the computer system 200 to access the Internet or other computer networks.

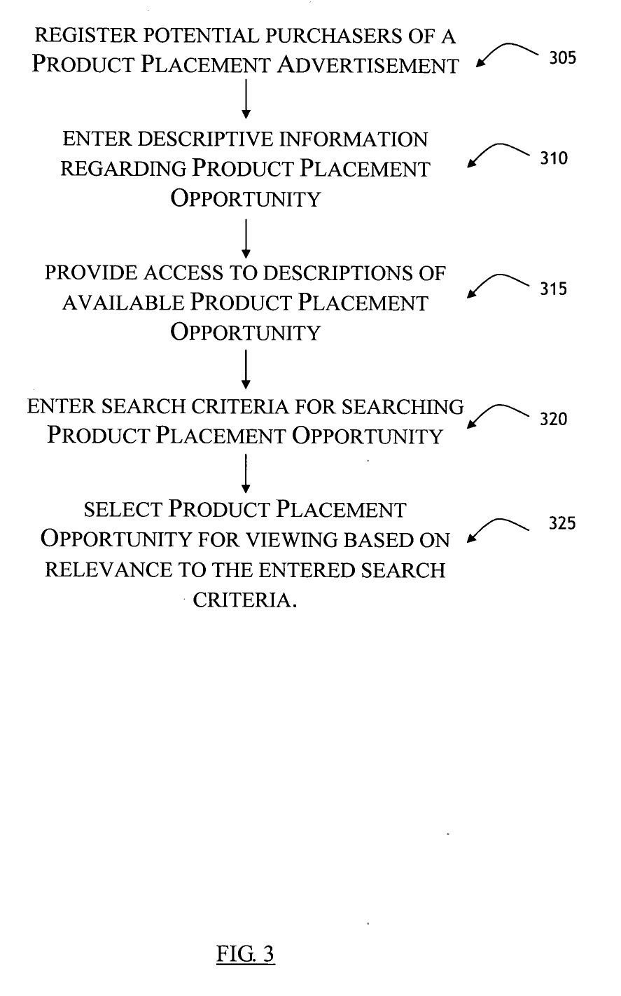

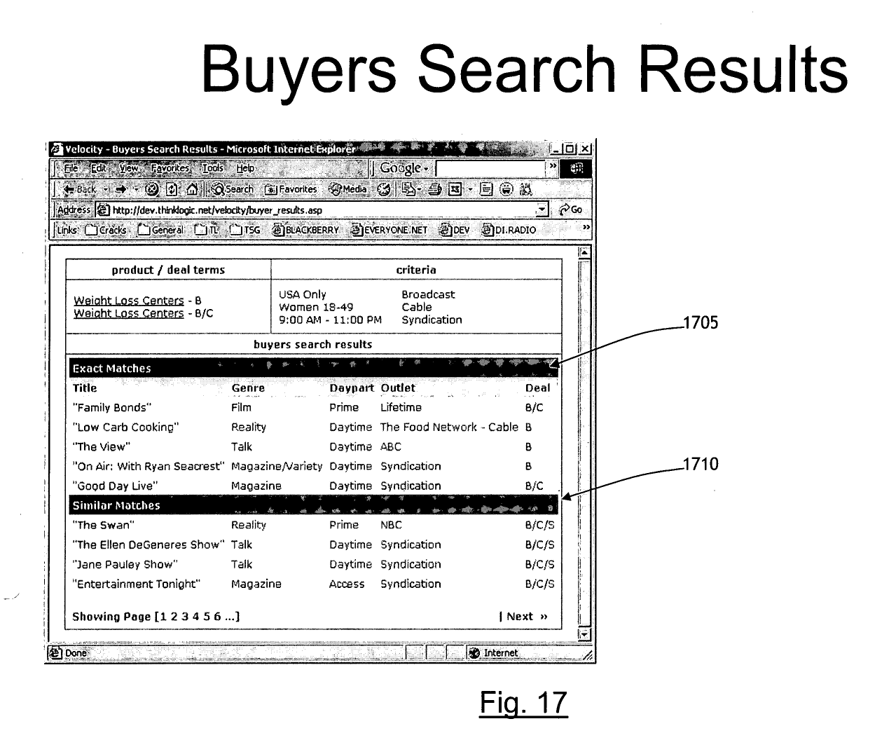

With reference now to FIGS. 3-22, an exemplary embodiment of the present invention will now discussed. As will be explained in detail below, the present invention allows sellers, such as television and film companies to advertise and make known the details of product placement opportunities which they wish to sell as product placement advertisements. Sellers may also include direct to DVD/Video producers, distributors, broadcast networks, cable networks, syndication companies, local broadcast TV stations, cable system operators, and satellite distribution companies. Sellers may also include producers of other entertainment products such as video game developers, video game publishers, music labels, concert promoters, and live theater. Further, additional sellers may include sports teams and promoters.

Each of these sellers may be selling pre-production product placement opportunities where a product is actually used or displayed during a live event or while during the initial filming of a show. Alternatively, these sellers may also sell post-production product placement opportunities where a product may be digitally inserted into a film or television show after the initiation filming of the event.

Buyers of product placement advertisements may include almost any type of advertiser or company interested in advertising. These companies may include: advertising agencies, brand managers, marketing firms, public relations firms, retailers chain stores, consumer product manufacturers, pharmaceutical companies, product placement firms, e-Commerce websites, airlines, alcohol and beverage firms, magazine publishers and book publishers. Regardless of the type of company, the present invention will allow a potential advertiser to search and select product placement opportunities which are the most promising from them.

With reference now to FIG. 3, a preferred embodiment of the present invention illustrating a preferred method will now be discussed. Preferably, this method will be performed by computer program resident on a computer system which users may access via the Internet. Preferably, the computer system includes a server which may store and retrieve data to and from one or more databases.

As shown in Step 305, a first preferred step of the present invention is to register potential purchasers of product placement advertisements. Preferably, this process will preferably include a data entry screen which sellers can use to enter pertinent business and contact information into displayed fields. According to a preferred embodiment, registered users preferably may receive a user ID and password for gaining future access to the computer program.

As shown in Step 310, a second preferred step is to allow sellers to enter descriptive information regarding product placement opportunities. Preferably, this descriptive information may be entered through a series of drop-down menus and text fields. The descriptive information may preferably include a number of terms which will be of interest to potential buyers of product placement advertisements. According to a preferred embodiment, the descriptive information may include, for example: the name of the program in which the product placement opportunity exists, the type of media outlet for the product placement opportunity, the genre of the product placement opportunity, time and date of airing of the product placement opportunity, demographic information relevant to the product placement opportunity, and/or a narrative description of the program in which the product placement opportunity exists

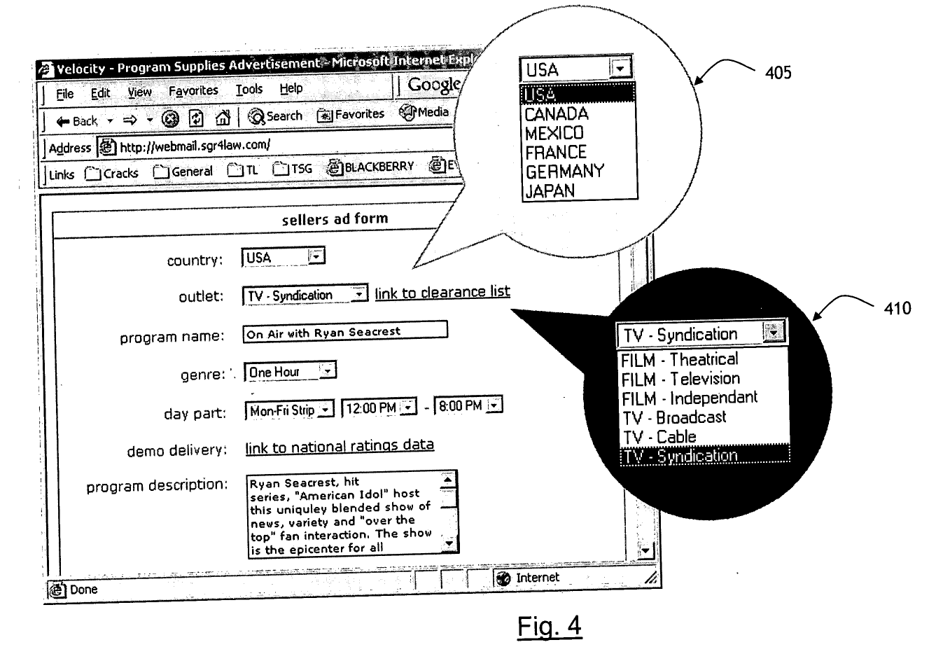

As shown in FIG. 4, the information may also include the relevant country for the product placement opportunity. This list of countries may be provided as a drop-down menu 405.

As further shown in FIG. 4, the information may also include the types of media outlets in which the product placement opportunity exists. These may be provided in a drop-down menu 410 and may include options such as: syndicated TV shows, cable TV shows, broadcast TV shows, independent films, television films, theatrical films or other types of media outlets.

As shown in FIG. 5, access to a clearance list 510 showing relevant market and station information for the product placement opportunity may be provided. This access may be provided via a link 505 or, alternatively, via a searchable database.

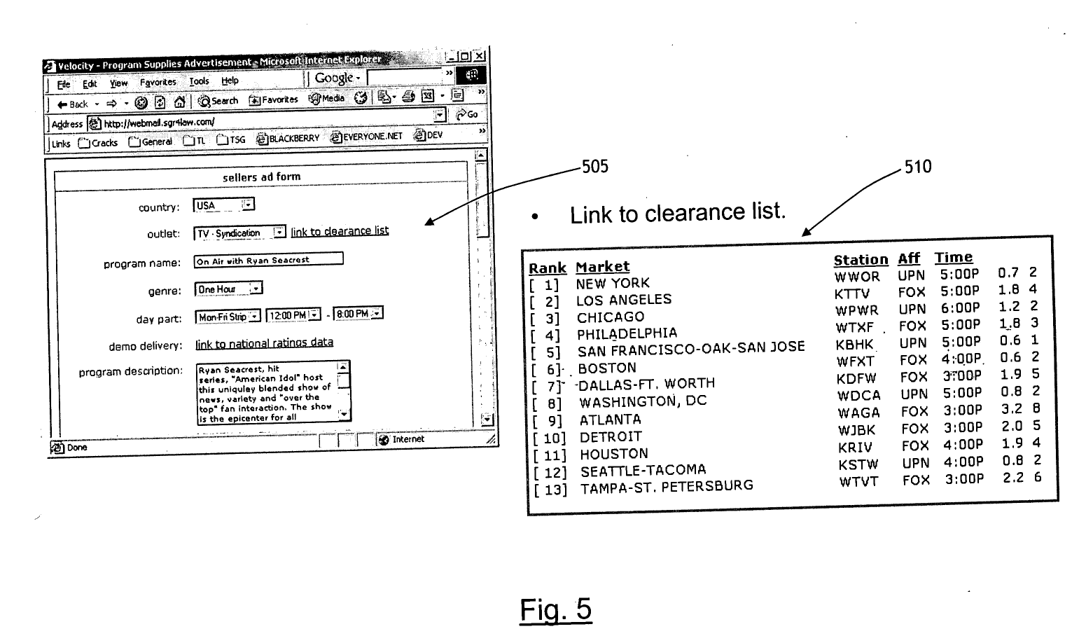

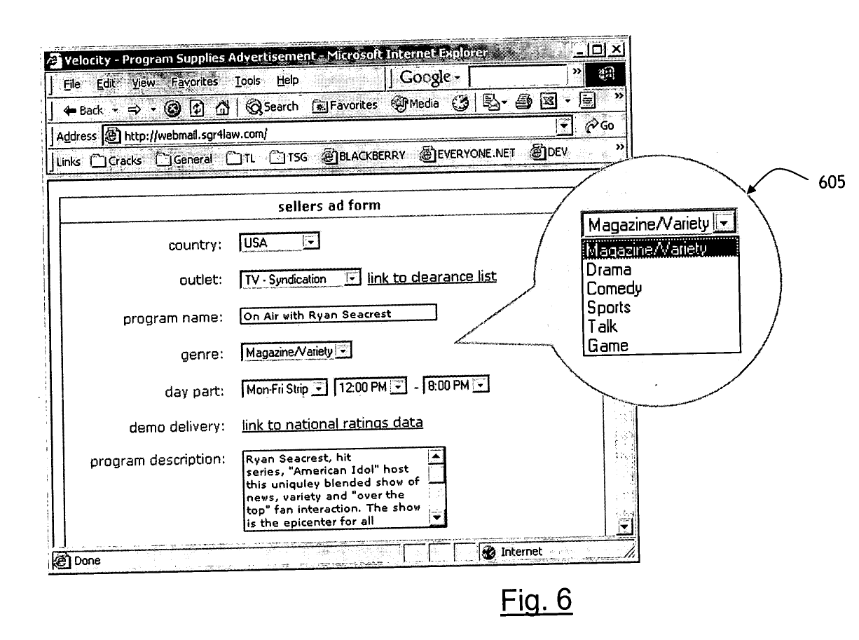

As shown in FIG. 6, the type of genre for a product placement opportunity may be provided in a drop-down menu 605. The types of genre which may be used may include options such as: drama, comedy, sports, talk, game, magazine and variety.

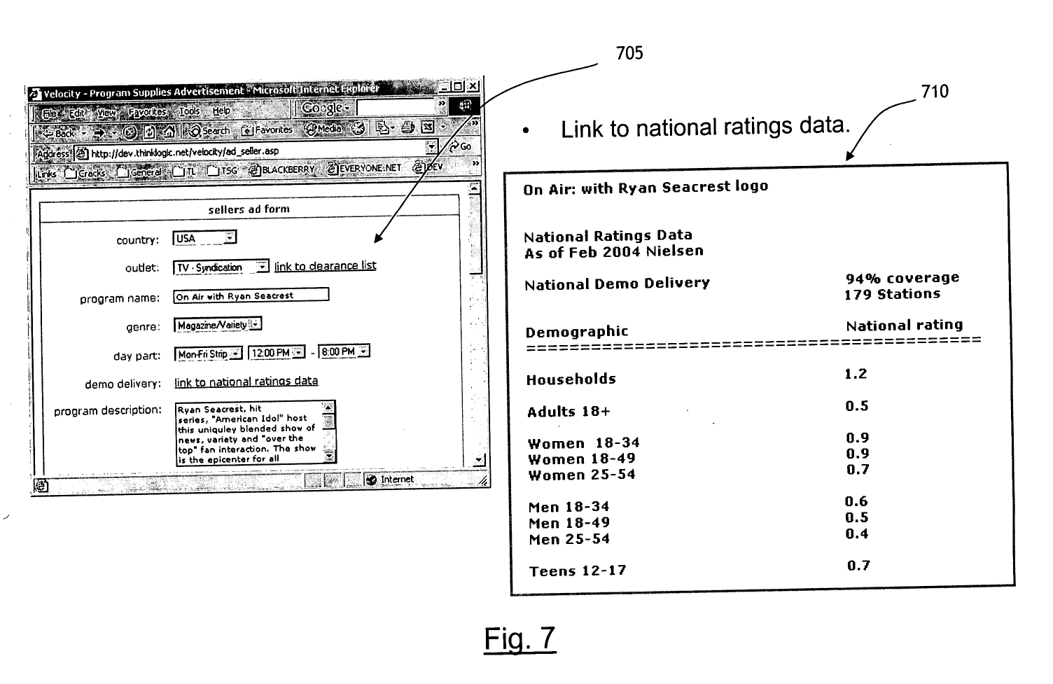

As shown in FIG. 7, a demographic information 710 relevant to the product placement opportunity may also be provided. This access may be provided via a link 705 or, alternatively, via a searchable database.

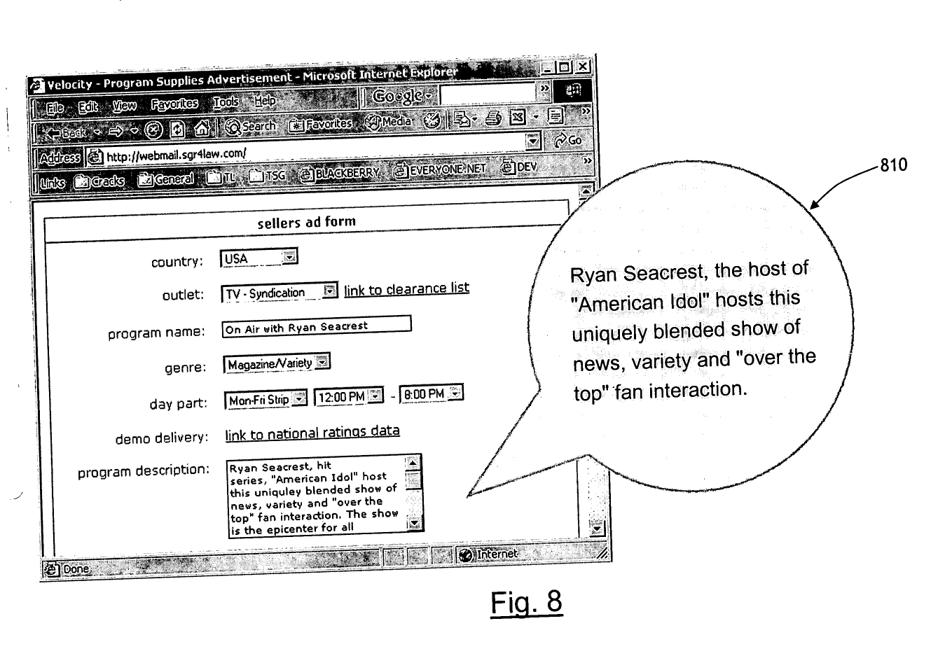

As shown in FIG. 8, a narrative description 810 of a program offering a product placement opportunity may also be provided. This narrative description preferably is searchable via a text searching tool.

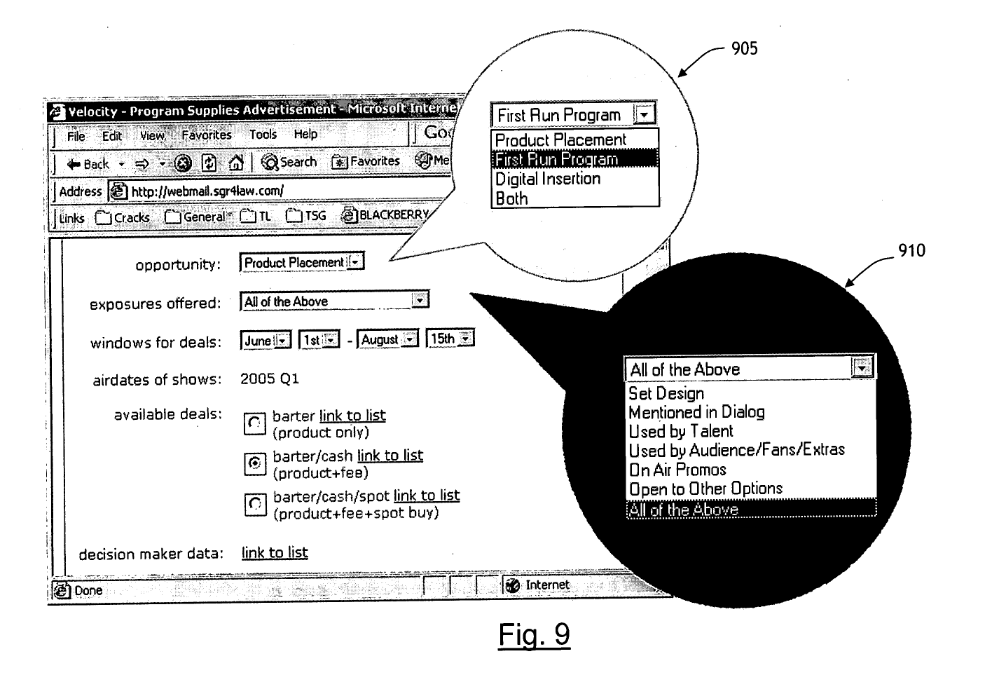

As shown in FIG. 9, a further description of the product placement opportunity may also be provided to allow users, for instance, to specify whether the product placement opportunity occurs within a first run program, a re-run program, and/or whether it is for a traditional product placement (i.e. use of an actual product) or a proposed digital insertion of a product or advertisement. This list of choices may be provided via a drop-down menu 905.

As further shown in FIG. 9, a description may be provided which details how a proposed product will be used within given product placement advertisement. These descriptions may include, for instance, how a product is proposed to be used in a product placement, such as: in the set design, mentioned in dialog, used by an actor, used by an extra, used in a related promotion, and whether any other options are available. This list of choices may be provided via a drop-down menu 910.

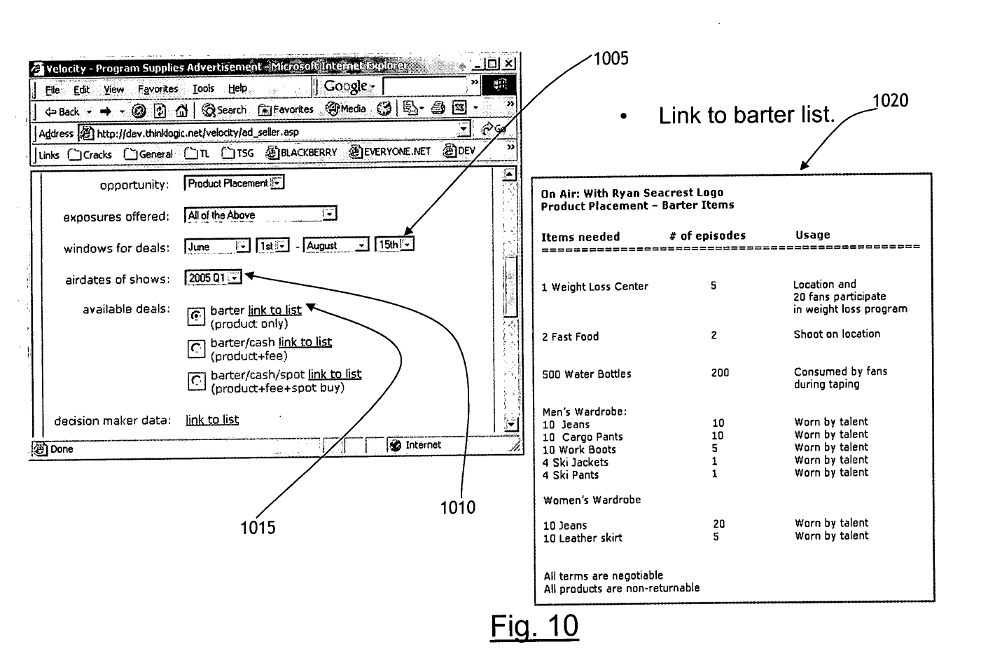

As shown in FIG. 10, the descriptive information may also include date range or window of agreeing to deals for product placement opportunity. This list of choices may be provided via a drop-down menu 1005.

As further shown in FIG. 10, the descriptive information may also include the airdate of the show in which the product placement opportunity is available. This information may also be selected via a drop-down menu 1010.

As further shown in FIG. 10, in addition to the descriptive terms listed above, sellers may preferably also provide the commercial terms under which they would be willing to sell a product placement advertisement. These terms may include the price the seller is charging for a product placement advertisement. Additionally, these terms may also options to purchase a product placement advertisement for barter. Under this arrangement, a seller may advertise that they are willing to sell a product placement advertisement (i.e. showing or using a specific type of car in a movie) in exchange for the free use of the product in the production. Such a choice may be provided via a link 1015 to a descriptive list of barter product placement opportunities 1020.

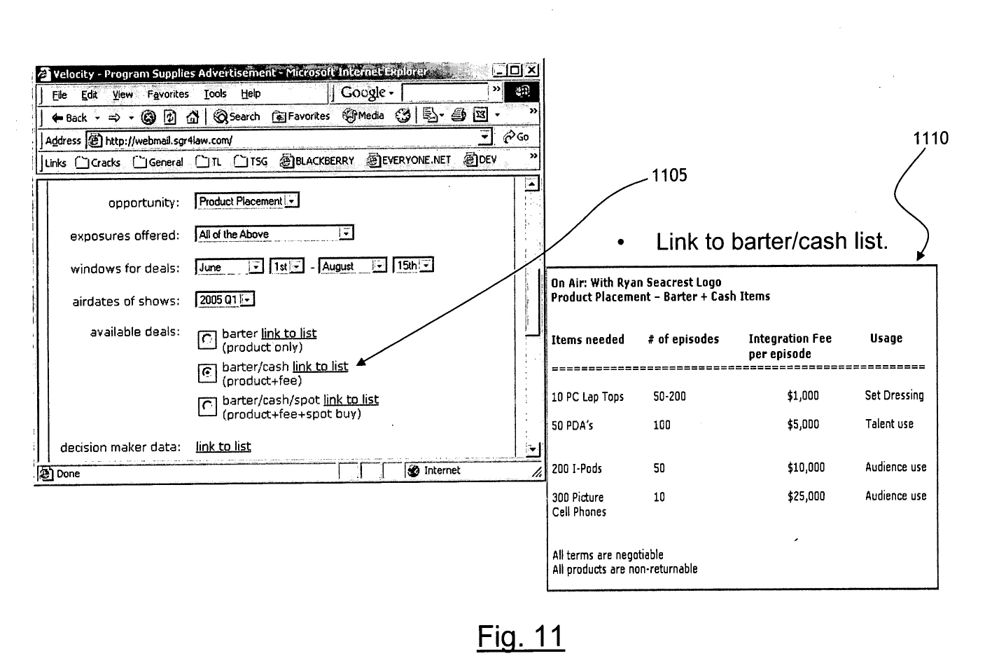

As shown in FIG. 11, the prospective commercial terms for a product placement opportunity may also include an option of having a barter arrangement which includes a product placement fee. As shown, such a choice may be provided via a link 1105 to a descriptive list of barter-plus-fee type product placement opportunities 1110.

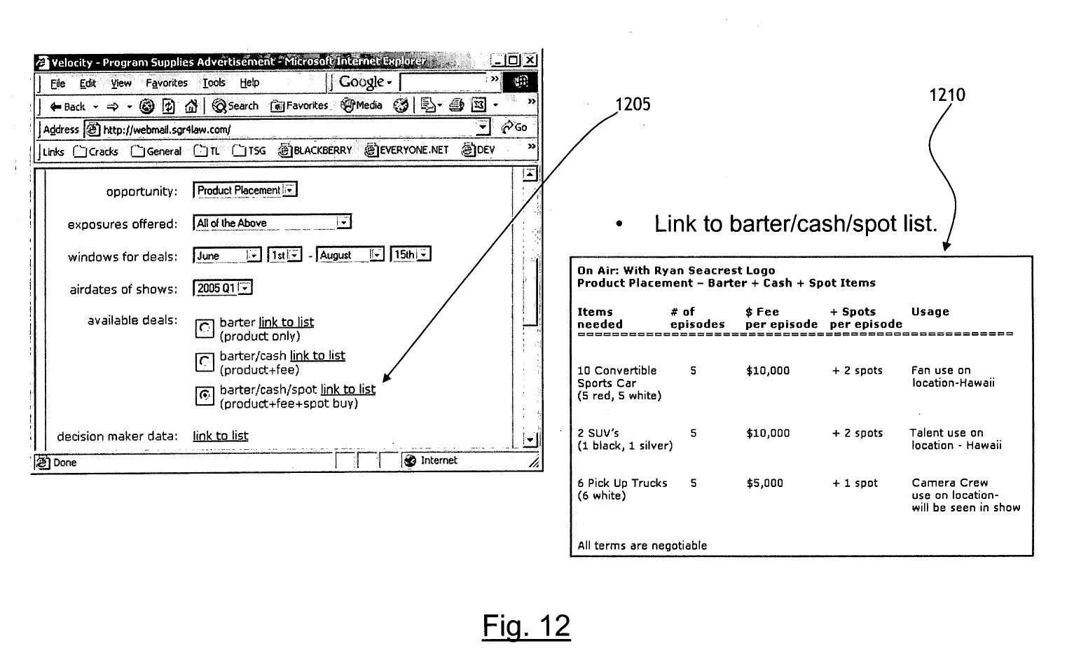

As shown in FIG. 12, further, the commercial terms may include an option for an arrangement which offers the purchase of a product placement advertisement in exchange for barter, payment of a fee, and an agreement to by a traditional advertising spot. As shown, such a choice may be provided via a link 1205 to a descriptive list of barter-fee-spot type product placement opportunities 1210.

Additionally, numerous other types of commercial terms and arrangements may be provided by sellers and made searchable for buyers.

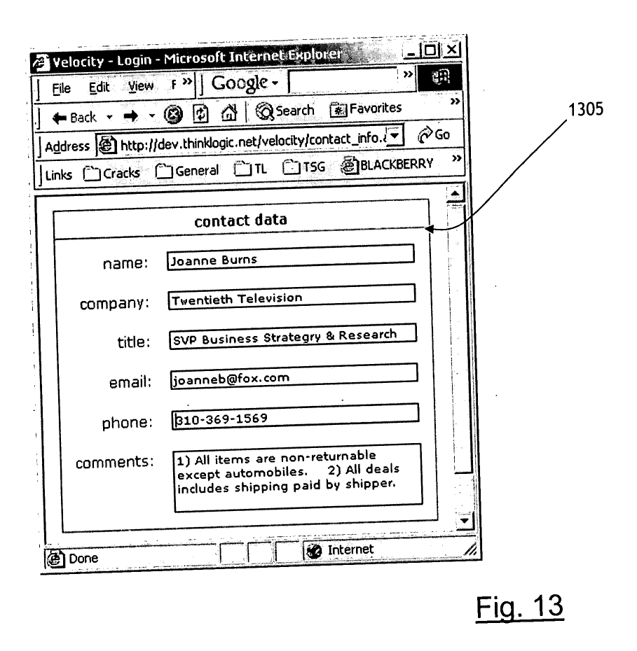

With reference now to FIG. 13, according to a further preferred embodiment, sellers may also provide contact information 1305 and decision maker information for each product placement opportunity.

Referring back to FIG. 3, once selling data is entered into the system for a product placement opportunity, as shown in Step 315, a third preferred step of the present invention is to provide users access to descriptions of the available product placement opportunities. Preferably, this access is provided via an Internet connection which displays listings of product placement opportunities via an HTTP or similar connection.

With further reference to FIG. 3, a fourth preferred step, Step 320, of the present invention provides users the opportunity to enter specific search criteria. Preferably, this search criteria is designed to include terms corresponding to the descriptive information entered by the sellers. Accordingly, it is preferable that search criteria include data such as the price of the product placement opportunity, the type of product, type of spot, type of media outlet, date of product placement opportunity, time of day of product placement opportunity and the genre of the product placement opportunity. Further, it is preferable that the search criteria include data such as the commercial terms available for securing a product placement opportunity and preferred target demographics.

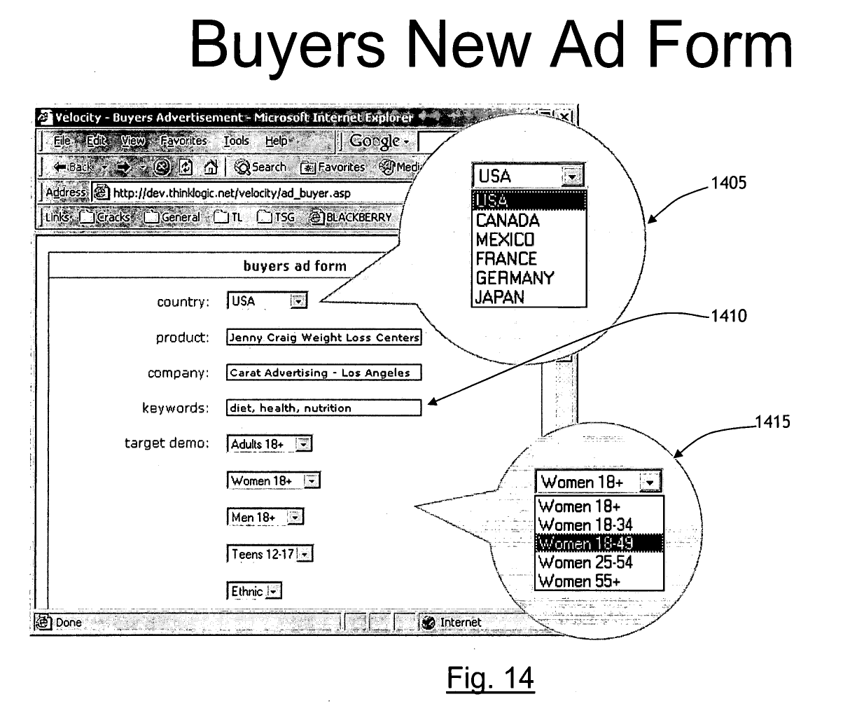

As shown in FIG. 14, buyers may enter search criteria such as the desired country 1405 and the target demographic 1415. Further, the search criteria may include key words 1410 which can be used to search descriptive information provided by sellers.

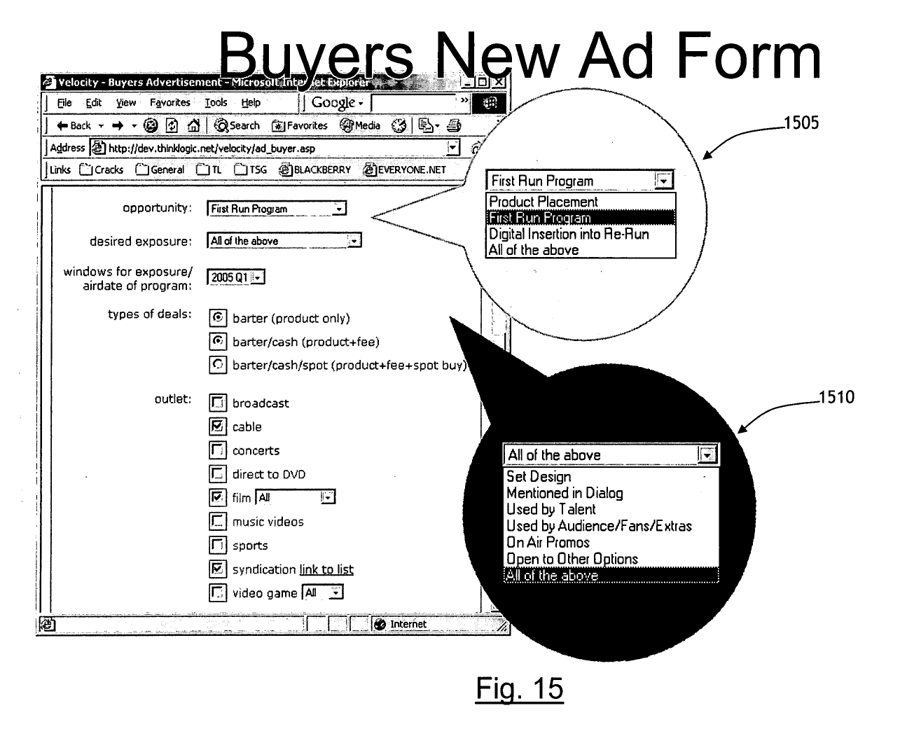

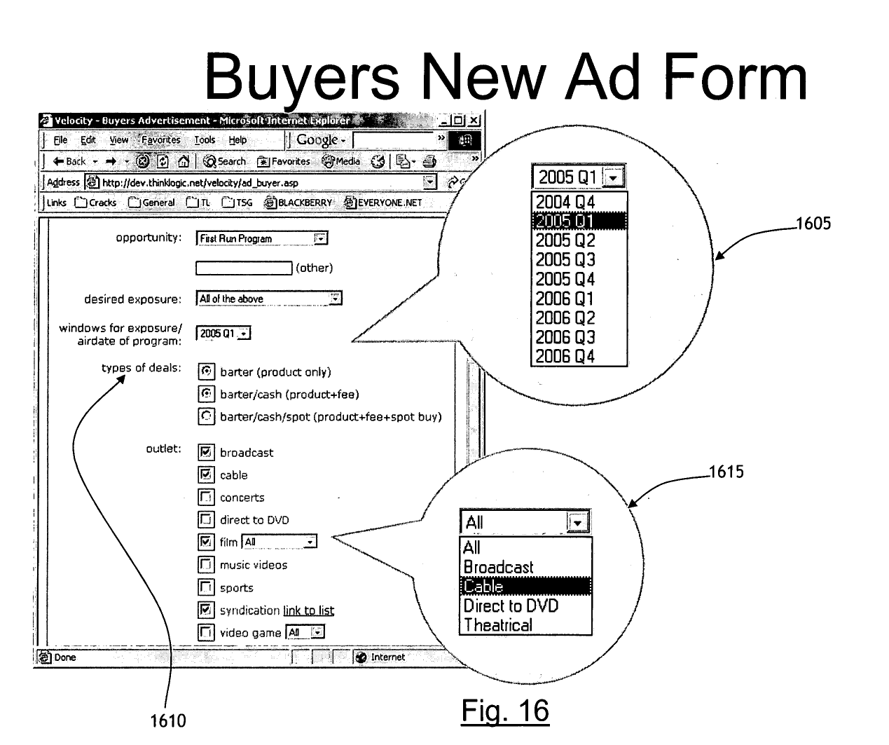

With reference to FIGS. 15, and 16, additional search criteria preferably corresponding to the descriptive information entered by the participating sellers of product placement advertisements may also be entered by a perspective buyer. These criteria may include, for instance: whether product placement opportunity occurs within a first run program, a re-run program, and/or whether it is a traditional product placement or digital insertion of a product 1505; how a proposed product will be used 1510 within given product placement advertisement; the date range or window for deals and airdates for programs 1605; types of commercial terms available to purchase a product placement advertisement 1610 (i.e. barter, barter+fee, barter+fee+spot); and the type of media outlet 1615 expected to be used. Finally, it is preferably that buyer contact and decision maker information is provided.

Referring back to FIG. 3, in Step 325, once the search criteria is entered, the search criteria may then be compared to the entered descriptive information to select the most relevant product placement opportunities for viewing by the potential buyer. As shown in FIG. 20, this information is preferably presented in chart form showing exact matches 2005 and similar matches 2010 based on similarities between the descriptive information entered by the buyers and search criteria entered by the seller.

While the invention has been described in terms of its preferred embodiments, it should be understood that numerous modifications may be made thereto without departing from the spirit and scope as defined in the appended claims. For instance, potential promotions and sponsorship opportunities may also be included, described and searched for like product placement opportunities. Likewise, licensing opportunities may also be included with descriptions and search terms germane to each market.

1. A method for facilitating the purchase of a product placement advertisement, the method comprising the following steps:
registering potential purchasers of a product placement advertisement;
entering descriptive information regarding product placement opportunities;
providing access to the descriptions of available product placement opportunities;
providing a data entry system for entering specific search criteria for searching product placement opportunities;
searching entered descriptive information for product placement opportunities; and
selecting product placement opportunities for viewing based on relevance to the entered search criteria.

2. The method of claim 1, wherein the descriptive information for a product placement opportunity includes the name of the program in which a product placement opportunity exists.

3 The method of claim 1, wherein the descriptive information includes the type of media outlet for the product placement opportunity.

4. The method of claim 3, wherein, the type of media outlets includes at least one outlet from the group containing: syndicated TV shows, cable TV shows, broadcast TV shows, independent films, television films, and theatrical films

5. The method of claim 2, wherein the descriptive information for a product placement opportunity includes the genre of the program in which a product placement opportunity exists.

6. The method of claim 5, wherein, the type of genre includes at least one genre from the group containing: drama, comedy, sports, talk, game, magazine and variety.

7. The method of claim 2, wherein the descriptive information for a product placement opportunity includes the time and date airing for the program in which a product placement opportunity exists.

8. The method of claim 2, wherein the descriptive information for a product placement opportunity includes demographic information for the program in which a product placement opportunity exists.

9. The method of claim 8, wherein the demographic information is provided via link to an database containing demographic information.

10. The method of claim 8, wherein the descriptive information for a product placement opportunity includes a narrative description of the program in which a product placement opportunity exists.

11. The method of claim 2, wherein the descriptive information for a product placement opportunity includes a clearance list.

12. The method of claim 2, wherein the descriptive information includes under what commercial terms a product placement advertisement can be secured.

13. The method of claim 12, wherein the commercial terms include at least one term from the group of terms containing: barter, barter plus fee; and barter plus fee plus spot buy.

14. The method of claim 12, wherein the commercial terms include the price of the product placement advertisement.

15. The method of claim 1, wherein product placement opportunities are searchable by at least one search criteria from the group of criteria containing: price, type of product, type of spot, type of media outlet, date of product placement opportunity, time of day of product placement opportunity, genre, and commercial terms available for securing a product placement opportunity.

16. The method of claim 1, wherein product placement opportunities are searchable by specific target demographics.

17. The method of claim 1, wherein product placement opportunities are searchable by specific price.

18. The method of claim 1, wherein product placement opportunities are searchable by type of product.

19. In a system containing stored descriptive information regarding product placement opportunities and a search engine for searching stored descriptive information; a method for selecting product placement opportunities for viewing, the method comprising the following steps:
providing access to potential purchasers of product placement advertisers;
allowing users to enter search criteria for searching stored descriptive information.

20. The method of claim 19, wherein the descriptive information includes the type of media outlet for the product placement opportunity.

21. The method of claim 20, wherein, the type of media outlets includes at least one outlet from the group containing: syndicated TV shows, cable TV shows, broadcast TV shows, independent films, television films, and theatrical films.

22. The method of claim 19, wherein the descriptive information includes the name of the program in which a product placement opportunity exists.

23. The method of claim 22 wherein the descriptive information includes the genre of the program in which the product placement opportunity exists.

24. The method of claim 23, wherein, the type of genre includes at least one genre from the group containing: drama, comedy, sports, talk, game, magazine and variety.

25. The method of claim 19, wherein the descriptive information includes the time and date airing for the program in which a product placement opportunity exists.

26. The method of claim 19, wherein the descriptive information includes demographic information for the program in which a product placement opportunity exists.

27. The method of claim 26, wherein the demographic information is provided via link to an database containing demographic information.

28. The method of claim 19, wherein the descriptive information includes a narrative description of the program in which a product placement opportunity exists.

29. The method of claim 19, wherein the descriptive information for a product placement opportunity includes a clearance list.

30. The method of claim 19, wherein the descriptive information includes under what commercial terms a product placement advertisement can be purchased.

31. The method of claim 30, wherein the commercial terms include at least one term from the group of terms containing: barter, barter-plus-fee; and barter-plus-fee-plus-spot buy.

32. The method of claim 31, wherein the commercial terms include the price of the product placement advertisement.

33. The method of claim 19, wherein the product placement opportunities are searchable by at least one type of descriptive information from the group of descriptive information containing: price, type of product, type of spot, type of media outlet, date of product placement opportunity, time of day of product placement opportunity, genre, and commercial terms available for securing a product placement opportunity.

34. The method of claim 19, wherein product placement opportunities are searchable by specific target demographics.

35. The method of claim 19, wherein product placement opportunities are searchable by specific price.

36. The method of claim 19, wherein product placement opportunities are searchable by type of product.

37. A system for facilitating the purchase of a product placement advertisement, the method comprising the following steps:
a data entry element for allowing the entry of descriptive information regarding product placement opportunities;
a data searching element for allowing the entry of search criteria for searching descriptive information for product placement opportunities; and
a data transmission element for transmitting data regarding product placement opportunities which are selected based on their relevance to the entered search criteria.

38. The system of claim 37, wherein product placement opportunities are searchable by at least one search criteria from the group of criteria containing: price, type of product, type of spot, type of media outlet, date of product placement opportunity, time of day of product placement opportunity, genre, and commercial terms available for securing a product placement opportunity.

39. The system of claim 37, wherein product placement opportunities are searchable by specific target demographics.

40. The system of claim 37, wherein product placement opportunities are searchable by specific price.

41. The system of claim 37, wherein product placement opportunities are searchable by type of product.
